(19) United States
(12) Patent Application Publication
(10) Pub. No.: US 2004/0142622 A1
(43) Pub. Date: Jul. 22, 2004

(54) Nonwoven barrier fabric comprising frangible fibrous component

(76) Inventor: Jerry Zucker, Charleston, SC (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 10/689,886

(22) Filed: Oct. 21, 2003

Related U.S. Application Data
(60) Provisional application No. 60/420,141, filed on Oct. 22, 2002.

(51) Int. Cl. D04H 1/46; D04H 5/02; B32B 27/12; B32B 5/26; D04H 5/00; D04H 1/00; D04H 3/00; D04H 13/00; D04H 1/06; D04H 3/10

(52) U.S. Cl. 442/408; 442/394; 442/340; 442/346; 442/351; 442/359; 442/360

(57) ABSTRACT

The present invention is directed to nonwoven barrier fabrics, and more specifically, to medical, hygiene and industrial articles comprised of nonwoven compound fabrics with improved barrier to basis weight performance, wherein the improved nonwoven compound fabrics are prepared by forming an intermediate nonwoven construct by supplying a strong and durable substrate layer followed by deposition of a frangible fibrous layer onto the substrate layer thereby providing nonwoven barrier materials. The so formed intermediate construct is subsequently subjected to mechanical energy which induces the frangible fibrous layer to fragment into sub-fibers exhibiting an equivalent denier as the frangible fibrous component, said sub-fibers becoming inter-engaged in the strong and durable substrate layer, thereby providing nonwoven barrier materials exhibit useful barrier performance.

### TECHNICAL FIELD

The present invention relates generally to nonwoven barrier fabrics, and more specifically, to medical, hygiene, and industrial articles comprised of nonwoven compound fabrics with improved barrier to basis weight performance, wherein the nonwoven barrier fabrics are prepared by forming an intermediate nonwoven construct comprising a strong and durable substrate layer and a frangible fibrous layer. The so formed intermediate construct is subsequently subjected to mechanical energy which induces the frangible fibrous layer to fragment into sub-fibers having an equivalent denier, said sub-fibers further becoming inter-engaged in the strong and durable substrate layer, thereby providing nonwoven barrier materials which exhibit useful barrier performance.

### BACKGROUND OF THE INVENTION

Nonwoven fabric constructs are used in a very wide variety of applications in which the engineered qualities of such materials can be advantageously employed. Nonwoven fabric webs may be formed from fibrous material in the form of natural or synthetic fibers, or substantially continuous filaments, with the materials from which such fabrics are formed, and the nature of the fabrication process, determining the physical characteristics of the resultant fabric.

Nonwoven fabric constructs may include plural or composite fabric layers, including composite structures formed from laminations of nonwoven fabrics and polymeric films, and through the entanglement of cellulosic wood pulp fibers into fibrous bases substrates. A particularly representative process wherein wood pulp fibers are used to form nonwoven barrier-type nonwoven fabrics is represented by U.S. Pat. No. 6,381,817, hereby incorporated by reference.

Nonwoven fabric constructs have proven to be particularly suitable for a variety of medical, hygiene and industrial applications as the cost-effective construction process allows for use in disposable/limited use articles. Use of such materials for medical gowns, sanitary products, and the like has become increasingly widespread, as the physical properties and characteristics of the nonwoven fabric constructs can be selected to meet the specific application requirements. For example, in protective medical applications, it is important that a nonwoven fabric construct functions as a fluidic barrier, so that specific clothing formed from such a material provides the user necessary protection against blood, body fluids, and other potentially infectious materials. While nonwoven fabric materials in the form of nonwoven laminates have been used in the past, such materials have typically included internally or topically treated conventional spunbond/meltblown/spunbond (SMS) fabrics, entangled fiber pulp [EFP] constructs, and the like.

The present nonwoven barrier fabric is intended to provide improved barrier protection through use of a strong and durable substrate layer compounded with a frangible fibrous layer wherein the frangible fibrous layer is fragmented and inter-entangled into the substrate layer by application of external energy, thereby forming a material imminently useful for medical, hygiene, and industrial applications, lending itself to cost-effective, disposable use.

### SUMMARY OF THE INVENTION

The present invention is directed to nonwoven barrier fabrics, and more specifically, to medical, hygiene and industrial articles comprised of nonwoven compound fabrics with improved barrier to basis weight performance, wherein the improved nonwoven compound fabrics are prepared by forming an intermediate nonwoven construct by supplying a strong and durable substrate layer followed by deposition of a frangible fibrous layer onto the substrate layer thereby providing nonwoven barrier materials. The so formed intermediate construct is subsequently subjected to mechanical energy which induces the frangible fibrous layer to fragment into sub-fibers exhibiting an equivalent denier as the frangible fibrous component, said sub-fibers becoming inter-engaged in the strong and durable substrate layer, thereby providing nonwoven barrier materials exhibit useful barrier performance.

A particularly preferred barrier layer preferentially comprises a frangible fibrous layer of infinite length filaments, wherein the average diameter of the filament is in the range of less than or equal to 10000 nanometers, preferably less than or equal to 2000 nanometers, and most preferably less than or equal to 500 nanometers, is applied to at least one strong and durable substrate layer. Said substrate layer or layers and said frangible fibrous layer or layers, and optionally one or more secondary barrier materials, are consolidated into a single compound fabric by the application of external energy. Hydraulic energy, as practiced through conventional hydroentanglement practices as described in U.S. Pat. No. ______ [Evans], hereby incorporated by reference, are preferred as the energy of the applied fluid can both induce fragmentation of the frangible fibrous layer into sub-fibers and coalesce the fragmented sub-fibers into the strong and durable substrate layer(s) so as to form a single compound fabric.

The thermoplastic polymers of the at least one frangible fibrous layer are chosen from the group consisting of polyolefins, polyamides, and polyesters, wherein the polyolefins are chosen from the group consisting of polypropylene, polyethylene, and combinations thereof, wherein the elastic modulus of the component frangible fibers is at least 20% less than that of the individual fibrous or unit-area film component of the strong and durable substrate layer. It is within the purview of the present invention that the frangible fibrous layer or layers may comprise either the same or different thermoplastic polymers. Further, the frangible fibrous layer or layers may comprise homogeneous, bicomponent, and/or multi-component profiles, as well as, performance modifying additives, and the blends thereof.

The strong and durable substrate layer comprises a material selected from suitable media, such media being represented by, but not limited to: continuous filament nonwoven fabrics, staple fiber nonwoven fabrics, continuous filament or staple fiber woven textiles, and films, wherein the elastic modulus of individual fibrous or unit-area film component of the strong and durable substrate layer are at least 25% greater than that of the component frangible fibers. The composition of the substrate layer may be selected from synthetic and natural materials and the blends thereof. In a fabric formed in accordance with the present invention, the incorporation of one or more frangible fibrous layers provide substantial improvement in barrier function, allowing for reduction in the total amount of the substrate and/or barrier layer required to meet barrier performance criteria.

It is also within the purview of the present invention that once the frangible fibrous layer and substrate layers are formed and integrated into a single compound barrier fabric, that other layers of substrate, frangible fibrous, and secondary barrier layers can be applied or laminated to the compound barrier fabric so as to obtain yet further modified performance attributes.

A further aspect of the present invention is directed to the fragmentation of the frangible fibrous layer providing a more uniform support layer for subsequently applied barrier layers or substrate layers during the manufacturing process, thus providing an improvement in barrier function of the resulting medical fabric.

Formation of fabrics from frangible fibrous materials, particularly when a light basis weight frangible continuous filaments is either coated or “dusted” onto a substrate layer or is combined with one or more conventional barrier layers, can provide enhanced barrier properties. The present invention allows for the production of a same weight fabric with improved barrier properties as well as a lighter weight fabric that is suitable for use as a barrier fabric, particularly for medical applications, such as disposable gowns and drapes.

Other features and advantages of the present invention will become readily apparent from the following detailed description, the accompanying drawings, and the appended claims.

### BRIEF DESCRIPTION OF THE DRAWINGS

FIG. 1 is a diagrammatic view of a surgical gown; and

FIG. 2 is a diagrammatic view of a disposable diaper.

### DETAILED DESCRIPTION

While the present invention is susceptible of embodiment in various forms, there will hereinafter be described, presently preferred embodiments, with the understanding that the present disclosure is to be considered as an exemplification of the invention, and is not intended to limit the invention to the specific embodiments disclosed herein.

The present invention is directed to medical gowns and drapes with an improved barrier performance due to the incorporation of frangible fibrous layer, and particularly frangible continuous filaments, and at least one substrate layer of strong and durable material. In order to achieve desired barrier properties to weight ratios for the compound structure, the frangible continuous filaments preferably have a denier of less than or equal to 10000 nanometers, more preferably having a denier of less than or equal to 2000 nanometers, and most preferably having a denier of less than or equal to about 500 nanometers.

The thermoplastic polymers of the at least one frangible fibrous layer are chosen from the group consisting of polyolefins, polyamides, and polyesters, wherein the polyolefins are chosen from the group consisting of polypropylene, polyethylene, and combinations thereof, wherein the elastic modulus of the component frangible fibers are at least 20% less than that of the individual fibrous or unit-area film component of the strong and durable substrate layer. It is within the purview of the present invention that the frangible fibrous layer or layers may comprise either the same or different thermoplastic polymers. Further, the frangible fibrous layer or layers may comprise homogeneous, bicomponent, and/or multi-component profiles, as well as, performance modifying additives, and the blends thereof.

The frangible continuous filaments can be obtained through suitable spinning means, as represented by conventional spunbond, meltblown, flashspun, and nano-denier technologies. Suitable nano-denier continuous filament barrier layers can be formed by either direct spinning of nano-denier filaments or by formation of a multi-component filament that is divided into nano-denier filaments prior to deposition on a substrate layer. U.S. Pat. No. 5,678,379 and U.S. Pat. No. 6,114,017, both incorporated herein by reference, exemplify direct spinning processes practicable in support of the present invention. Multi-component filament spinning with integrated division into nano-denier filaments can be practiced in accordance with the teachings of U.S. Pat. No. 5,225,018 and U.S. Pat. No. 5,783,503, both incorporated herein by reference.

Technologies capable of forming a strong and durable substrate layer include those which form continuous filament nonwoven fabrics, staple fiber nonwoven fabrics, continuous filament or staple fiber woven textiles (to include knits), and films. A substrate is determined to be strong and durable based upon the substrate having sufficient physical properties to withstand manufacturing and fabrication processes. Fibers and/or filaments comprising the strong and durable substrate layer are selected from natural or synthetic composition, of homogeneous or mixed fiber length. Suitable natural fibers include, but are not limited to, cotton, wood pulp and viscose rayon. Synthetic fibers, which may be blended in whole or part, include thermoplastic and thermoset polymers. Thermoplastic polymers suitable for blending with thermoplastic resins include polyolefins, polyamides and polyesters. The thermoplastic polymers may be further selected from homopolymers; copolymers, conjugates and other derivatives including those thermoplastic polymers having incorporated melt additives or surface-active agents.

In general, continuous filament nonwoven fabric formation involves the practice of the spunbond process. A spunbond process involves supplying a molten polymer, which is then extruded under pressure through a large number of orifices in a plate known as a spinneret or die. The resulting continuous filaments are quenched and drawn by any of a number of methods, such as slot draw systems, attenuator guns, or Godet rolls. The continuous filaments are collected as a loose web upon a moving foraminous surface, such as a wire mesh conveyor belt. When more than one spinneret is used in line for the purpose of forming a multi-layered fabric, the subsequent webs are collected upon the uppermost surface of the previously formed web. The web is then at least temporarily consolidated, usually by means involving heat and pressure, such as by thermal point bonding. Using this means, the web or layers of webs are passed between two hot metal rolls, one of which has an embossed pattern to impart and achieve the desired degree of point bonding, usually on the order of 10 to 40 percent of the overall surface area being so bonded.

Staple fibers used to form nonwoven fabrics begin in a bundled form as a bale of compressed fibers. In order to decompress the fibers, and render the fibers suitable for integration into a nonwoven fabric, the bale is bulk-fed into a number of fiber openers, such as a garnet, then into a card. The card further frees the fibers by the use of co-rotational and counter-rotational wire combs, then depositing the fibers into a lofty batt. The lofty batt of staple fibers can then optionally be subjected to fiber reorientation, such as by air-randomization and/or cross-lapping, depending upon the ultimate tensile properties of the resulting nonwoven fabric desired. The fibrous batt is integrated into a nonwoven fabric by application of suitable bonding means, including, but not limited to, use of adhesive binders, thermobonding by calender or through-air oven, and hydroentanglement.

The production of conventional textile fabrics is known to be a complex, multi-step process. The production of staple fiber yarns involves the carding of the fibers to provide feedstock for a roving machine, which twists the bundled fibers into a roving yarn. Alternately, continuous filaments are formed into bundle known as a tow, the tow then serving as a component of the roving yarn. Spinning machines blend multiple roving yarns into yarns that are suitable for the weaving of cloth. A first subset of weaving yarns is transferred to a warp beam, which, in turn, contains the machine direction yarns, which will then feed into a loom. A second subset of weaving yarns supply the weft or fill yarns which are the cross direction threads in a sheet of cloth. Currently, commercial high-speed looms operate at a speed of 1000-1500 picks per minute, whereby each pick is a single yarn. The weaving process produces the final fabric at manufacturing speeds of 60 inches to 200 inches per minute.

The formation of finite thickness films from thermoplastic polymers, suitable as a strong and durable substrate layer, is a well-known practice. Thermoplastic polymer films can be formed by either dispersion of a quantity of molten polymer into a mold having the dimensions of the desired end product, known as a cast film, or by continuously forcing the molten polymer through a die, known as an extruded film. Extruded thermoplastic polymer films can either be formed such that the film is cooled then wound as a completed material, or dispensed directly onto a secondary substrate material to form a composite material having performance of both the substrate and the film layers. Examples of suitable secondary substrate materials include other films, polymeric or metallic sheet stock, and woven or nonwoven fabrics.

Extruded films utilizing the composition of the present invention can be formed in accordance with the following representative direct extrusion film process. Blending and dosing storage comprising at least one hopper loader for thermoplastic polymer chip and, optionally, one for pelletized additive in thermoplastic carrier resin, feed into variable speed augers. The variable speed augers transfer predetermined amounts of polymer chip and additive pellet into a mixing hopper. The mixing hopper contains a mixing propeller to further the homogeneity of the mixture. Basic volumetric systems such as that described are a minimum requirement for accurately blending the additive into the thermoplastic polymer. The polymer chip and additive pellet blend feeds into a multi-zone extruder. Upon mixing and extrusion from the multi-zone extruder, the polymer compound is conveyed via heated polymer piping through a screen changer, wherein breaker plates having different screen meshes are employed to retain solid or semi-molten polymer chips and other macroscopic debris. The mixed polymer is then fed into a melt pump, and then to a combining block. The combining block allows for multiple film layers to be extruded, the film layers being of either the same composition or fed from different systems as described above. The combining block is connected to an extrusion die, which is positioned in an overhead orientation such that molten film extrusion is deposited at a nip between a nip roll and a cast roll.

When a substrate material is to receive a film layer extrusion, a substrate material source is provided in roll form to a tension-controlled unwinder. The substrate material is unwound and moves over the nip roll. The molten film extrusion from the extrusion die is deposited onto the secondary substrate material at the nip point between the nip roll and the cast roll to form a strong and durable substrate layer. The newly formed substrate layer is then removed from the cast roll by a stripper roll and wound onto a new roll.

It is within the purview of the present invention that a secondary barrier material can be combined with the frangible fibrous layer. Suitable secondary barrier materials can be selected from such representative materials as: meltblown fibers, nano-denier filaments, microporous films and monolithic films.

Meltblown fibers are particularly preferred as a supplemental or secondary barrier for the nonwoven fabric of the present invention. To form meltblown fibers, a molten polymer is extruded under pressure through orifices in a spinneret or die. High velocity air impinges upon and entrains the filaments as they exit the die. The energy of this step is such that the formed filaments are greatly reduced in diameter and are fractured so that microfibers of finite length are produced. This differs from the spunbond process whereby the continuity of the filaments is preserved. The process to form either a single layer or a multiple-layer fabric is continuous, that is, the process steps are uninterrupted from extrusion of the filaments to form the first layer until the bonded web is wound into a roll. Methods for producing these types of fabrics are described in U.S. Pat. No. 4,043,203. The meltblown process, as well as the cross-sectional profile of the spunbond filament or meltblown microfiber, is not a critical limitation to the practice of the present invention.

Further, breathable barrier films can be combined with the improved barrier performance imparted by combining the breathable barrier film with nano-denier continuous filaments. Monolithic films, as taught in U.S. Pat. No. 6,191,211, and microporous films, as taught in U.S. Pat. No. 6,264,864, both patents herein incorporated by reference, represent the mechanisms of forming such breathable barrier films.

To form the nonwoven fabric of the present invention, a one or more frangible fibrous layers are deposited on to one or more substrate layers. The frangible layer is then subjected to an external energy source, such as hydraulic energy, which subsequently fragments the frangible fibrous components into equivalent-denier sub-fibers. These sub-fibers are either simultaneously or subsequently integrated into the substrate layer so as to form a single compound fabric. While hydroentangling technologies are preferred, other technologies can be employed such that the frangible fibrous component's length is disrupted, and the resulting equivalent-denier sub-fibers integrated into the substrate layer. It is also within the purview of the present invention that once the frangible fibrous layer and substrate layers are formed and integrated into a single compound barrier fabric, that other layers of substrate, frangible fibrous, and secondary barrier layers can be applied or laminated to the compound barrier fabric so as to obtain yet further modified performance attributes.

It is believed that by providing a frangible fibrous layer upon which a subsequent secondary barrier layer may deposited, several enhancements of the fabric can be realized. For a given basis weight of the spunbond layer, a finer denier fabric will give a greater number of filaments and a smaller average pore size per unit area. The smaller average pore size will result in a more uniform deposition of the secondary barrier material onto the nano-denier barrier layer. A more uniform secondary barrier layer will also have fewer weak points in the web at which a failure in barrier performance can occur. The nano-denier barrier layer also serves to support the secondary barrier layer structurally in the compound nonwoven material. A nano-denier barrier layer provides a smaller average pore size and a larger number of support points for the secondary barrier layer, this results in shorter spans of unsupported secondary barrier material. This mechanism embodies the well-known concept that reduction in the average span length results in enhanced structural integrity.

Manufacture of nonwoven compound fabrics embodying the principles of the present invention includes the use of fibers and/or filaments having same or different composition in either or both of the frangible fibrous and substrate layers, such that the component of the frangible fibrous layer exhibits an elastic modulus of at least 20% less that of the individual fibrous component or film unit-area of the substrate layer. Differing thermoplastic polymers can optionally be compounded with the same or different performance improvement additives. Further, fibers and/or filaments may be blended with fibers and/or filaments that have not been modified by the compounding of additives.

Utilizing the above-discussed substrate and barrier layer manufacturing technologies, combinations of different constructs can be combined with a nano-denier barrier layer to yield compound nonwoven materials of further improved barrier performance. Such a performance is desirable among medical fabrics, specifically gowns and drapes.

Disposable medical and industrial protective fabrics, such as CSR, medical gown, surgical drape and oversuits can benefit significantly from the inclusion of an improved barrier fabric as described in the present invention. Of particular utility in the fabrication of such protective products is the use of lighter weight fabrics with improved barrier to weight ratios, as it is important for the finished product to be as lightweight as possible yet still perform its desired function. Patents generally describing such protective products include U.S. Pat. No. 4,845,779, U.S. Pat. No. 4,876,746, U.S. Pat. No. 5,655,374, U.S. Pat. No. 6,029,274, and U.S. Pat. No. 6,103,647, which are incorporated herein by reference.

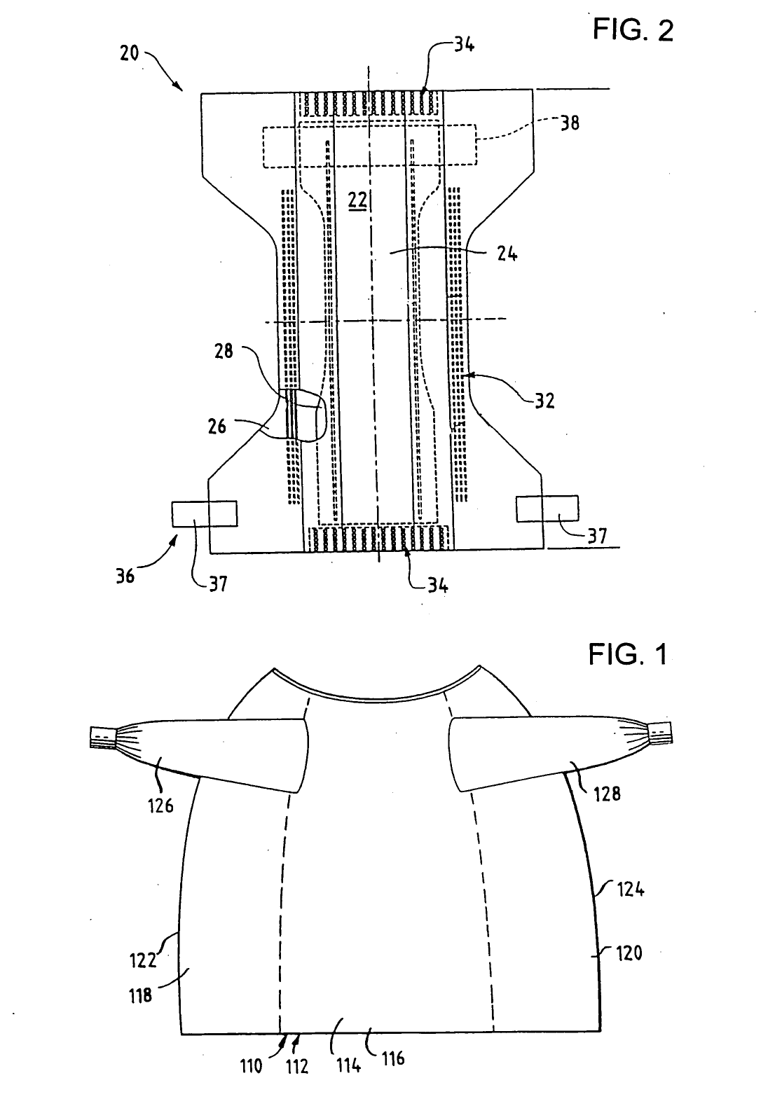

Referring now to FIG. 1, there is shown a disposable garment generally designated 110 comprising a surgical gown 112. The gown 112 comprises a body portion 114, which may be one-piece, having a front panel 116 for covering the front of the wearer, and a pair of back panels 118 and 120 extending from opposed sides of the front panel 116 for covering the back of the wearer. The back panels 118 and 120 have a pair of side edges 122 and 124, respectively, which define an opening on the back of the gown. The gown 112 has a pair of sleeves 126 and 128 that may optionally include wrist cuffs, secured to the body portion 114 of the gown for the arms of the wearer. In use, the back panels 118 and 120 overlap on the back of the wearer in order to close the back opening of the gown, and suitable belt means (not shown) is utilized to secure the back panels 118 and 120 in the overlapping relationship.

Practical application of an improved barrier fabric comprising a frangible fibrous layer as described in this invention for a medical gown, results in a gown that is lighter in weight while maintaining performance. A lighter weight material is expected to be more flexible and therefore more conforming to deformation of the overall structure as the gown is applied and worn while maintaining necessary barrier performance.

Additional constructs requiring significant barrier performance include disposable waste-containment garments and are generally described in U.S. Pat. No. 4,573,986, U.S. Pat. No. 5,843,056, and U.S. Pat. No. 6,198,018, which are incorporated herein by reference.

An absorbent article incorporating an improved barrier fabric of the present invention is represented by the unitary disposable absorbent article, diaper 20, shown in FIG. 1. As used herein, the term “diaper” refers to an absorbent article generally worn by infants and incontinent persons that is worn about the lower torso of the wearer. It should be understood, however, that the present invention is also applicable to other absorbent articles such as incontinence briefs, incontinence undergarments, diaper holders and liners, feminine hygiene garments, training pants, pull-on garments, and the like.

FIG. 2 is a plan view of a diaper 20 in an uncontracted state (i.e., with elastic induced contraction pulled out) with portions of the structure being cut-away to more clearly show the construction of the diaper 20. As shown in FIG. 1, the diaper 20 preferably comprises a containment assembly 22 comprising a liquid pervious topsheet 24; a liquid impervious backsheet 26 joined to the topsheet; and an absorbent core 28 positioned between the topsheet 24 and the backsheet 26. The absorbent core 28 has a pair of opposing longitudinal edges, an inner surface and an outer surface. The diaper can further comprise elastic leg features 32; elastic waist features 34; and a fastening system 36, which preferably comprises a pair of securement members 37 and a landing member 38.

Practical application of an improved barrier fabric comprising a frangible fibrous layer as described in this invention for backsheet 26 results in a diaper that is lighter in weight while maintaining performance. A lighter weight backsheet material is expected to be more flexible and therefore more conforming to deformation of the overall structure as the diaper is worn.

Catamenial products, such as feminine hygiene pads, are of the same general construction as the aforementioned diaper structure. Again, a topsheet and a backsheet are affixed about a central absorbent core. The overall design of the catamenial product is altered to best conform to the human shape and for absorbing human exudates. Representative prior art to such article fabrication include U.S. Pat. No. 4,029,101, U.S. Pat. No. 4,184,498, U.S. Pat. No. 4,195,634, U.S. Pat. No. 4,408,357 and U.S. Pat. No. 4,886,513, which are incorporated herein by reference.

From the foregoing, numerous modifications and variations can be effected without departing from the true spirit and scope of the novel concept of the present invention. It is to be understood that no limitation with respect to the specific embodiments disclosed herein is intended or should be inferred. The disclosure is intended to cover, by the appended claims, all such modifications as fall within the scope of the claims.

What is claimed is:

1. A nonwoven barrier fabric, comprising;
a. a frangible fibrous layer comprising a first fibrous component,
b. a substrate layer comprising a second fibrous component and/or unit-area film component,
c. wherein said first fibrous component of the frangible fibrous layer exhibits an elastic modulus at least 20% less than that of the second fibrous component and/or unit area component of the substrate layer,
d. said frangible fibrous layer being deposited upon said substrate layer and subjected to external energy such that the first fibrous component fragments into multiple sub-fibers, and
e. said sub-fibers being integrated into the substrate layer.

2. A nonwoven barrier fabric, comprising;
a. a frangible fibrous layer comprising a first fibrous component,
b. said first fibrous component having a denier of equal to or less than 500 nanometers,
c. a substrate layer comprising a second fibrous component,
d. said second fibrous component comprising finite staple length fibers,
e. wherein said first fibrous component of the frangible fibrous layer exhibits an elastic modulus at least 20% less than that of the second fibrous component and/or unit area component of the substrate layer,
f. said frangible fibrous layer being deposited upon said substrate layer and subjected to hydraulic energy such that the first fibrous component fragments into multiple sub-fibers, said sub-fibers having a denier the same as that of the first fibrous component, and
g. said sub-fibers being hydroentangled into the substrate layer.

3. A nonwoven barrier fabric as in claim 2, wherein said nonwoven fabric is a component in a medical barrier article.

4. A medical barrier article as in claim 3, wherein said article is a medical gown.

5. A medical barrier article as in claim 3, wherein said article is a medical drape.

6. A medical barrier article as in claim 3, wherein said article is a central supply wrap.

7. A nonwoven barrier fabric as in claim 2, wherein said nonwoven fabric is a component in a hygiene article.

8. A hygiene article as in claim 7, wherein said article is a diaper.

9. A hygiene article as in claim 7, wherein said article is a feminine hygiene pad.
